(19) United States
(12) Patent Application Publication
(10) Pub. No.: US 2006/0124163 A1
(43) Pub. Date: Jun. 15, 2006

(54) Crutch

(76) Inventor: Yu-Cheng Tu, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/009,062

(22) Filed: Dec. 13, 2004

(51) Int. Cl. A61H 3/02

(52) U.S. Cl. 135/79; 135/75

(57) ABSTRACT

A crutch has a body, a sleeve, a foot and an adjusting device. The body has two parallel bows. Each bow has a bottom and an attachment segment near the bottom of the bows. Each attachment segment has a length and a distal end at the bottom of the bow. The sleeve is mounted between the attachment segments of the bows, has a length significantly longer than the attachment segments and extends beyond the distal ends of the attachment segments. The foot is mounted slidably in the sleeve. The adjusting device is mounted in the foot piece to adjust the length of the crutch.

### BACKGROUND OF THE INVENTION

1. Field of the Invention

The present invention relates to a crutch, especially to a telescopic crutch.

2. Description of the Prior Arts

Crutches are used to help people who do not walk well. With reference to FIG. 4, a conventional crutch comprises two bows (50), a handgrip (51), a sleeve (60) and a foot (70). The bows (50) are parallel, and each of the bows (50) has a straight lower section. The straight lower section has a length and a distal end. The handgrip (51) is mounted adjustably between the bows (50). The sleeve (60) is mounted between the lower sections of the bows (50) and has a distal end and a length. The distal end of the sleeve (60) is aligned with the distal ends of the bows (50). The length of the sleeve (60) is the same as the length of lower sections of the bows (50). The foot (70) is mounted slidably in the sleeve (60), allows the length of the conventional crutch to be adjusted and has a distal end and a boot. The boot is mounted on the distal end of the foot (70) and grips the ground.

The distal ends of the sleeve (60) and the bows (50) are wide, are far from a person's eyes and may obstruct the person's view of boot. Consequently, a person using the conventional crutches can easily misplace the boot and trip or fall.

To overcome the shortcomings, the present invention provides a crutch that uses few materials and obviates or mitigates the problems with the conventional crutch.

### SUMMARY OF THE INVENTION

The main objective of the present invention is to eliminate unnecessary material in the crutch and simultaneously provide a structure that is less likely to cause accidents. The crutch in accordance with the present invention has a body, a sleeve, a foot and an adjusting device. The body has two parallel bows. Each bow has a bottom and an attachment segment near the bottom. Each attachment segment has a length and a distal end at the bottom of the bow. The sleeve is mounted between the attachment segments, has a length significantly longer than the attachment segments and extends beyond the distal ends of the attachment segments. The foot is mounted slidably in the sleeve. The adjusting device is mounted in the foot to adjust the length of the crutch.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a crutch in accordance with the present invention;

FIG. 2 is a side view of the crutch in FIG. 1;

FIG. 3 is a partially exploded perspective view of a foot, sleeve and attachment segments of the crutch in FIG. 1; and

FIG. 4 is a perspective view of a conventional crutch in accordance with the prior art.

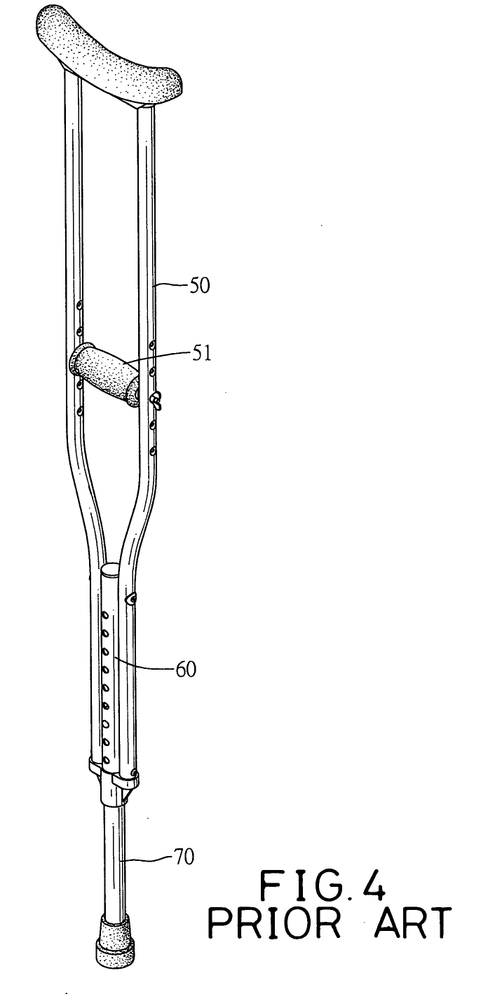

### DETAILED DESCRIPTION OF THE PREFERRED EMBODIMENTS

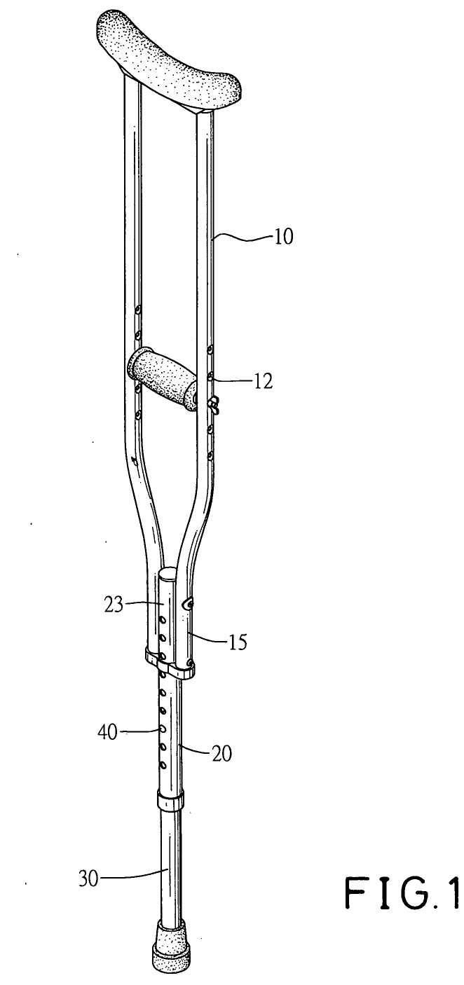

With reference to FIG. 1, a crutch in accordance with the present invention comprises a body (10), a sleeve (20), a foot (30) and an adjusting device (40).

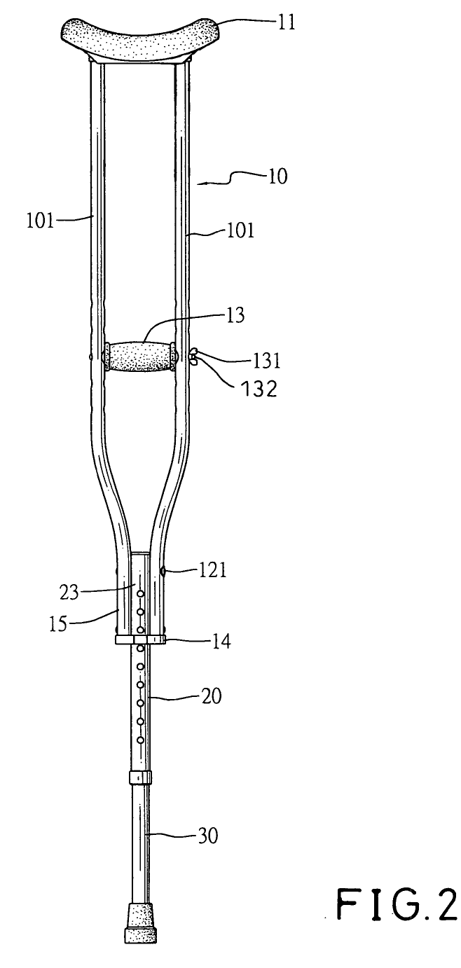

With further reference to FIG. 2, the body (10) has two bows (101), a pad (11), a handgrip (13) and an optional stationary end connector (14).

The bows (101) are parallel to each other, and each bow (101) has a top end, a bottom end, a middle, an attachment segment (15) and multiple optional through holes (12). The attachment segment (15) is formed near the bottom end, curves inwardly and has a length and multiple optional fastening holes (121). The through holes (12) are formed sequentially in pairs in the middle of the bows (101).

The pad (11) is attached to the top ends of the bows (101).

The handgrip (13) is mounted between the middle of the bows (101) and may have a bolt (132) and a wing nut (131). The bolt (132) passes through a through hole (12) in one bow (101), the handgrip (13) and a corresponding through hole (12) in the other bow (101). The wing nut (131) screws onto the bolt (132) to hold the handgrip (13) in place. The handgrip (13) can be fastened between any corresponding through holes (12) to accommodate a particular user.

The stationary end connector (14) is attached to the bottom end of the bows (101) and has a central hole.

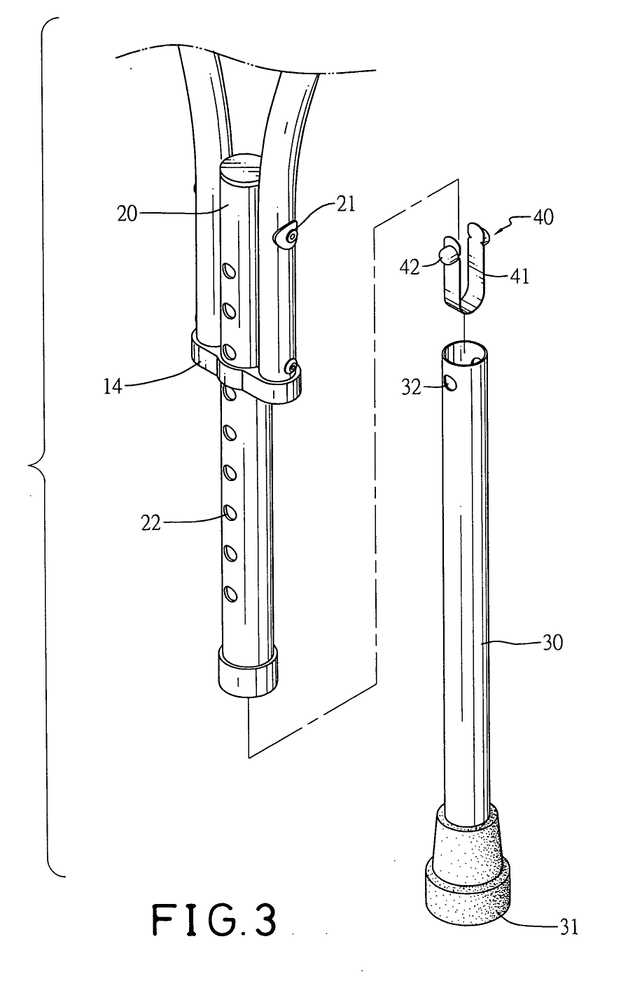

With further reference to FIG. 3, the sleeve (20) is hollow, has a length, a top section (23) and a bottom opening and may have multiple fastening elements (21) and multiple locking holes (22). The length of the sleeve (20) is longer than the length of the attachment segment (15). The top section (23) passes through the central hole in the stationary end connector (14) and is attached securely between the attachment segments (15) of the bows (101). The fastening elements (21) pass respectively through the fastening holes (121) in the attachment segments (15) and attach the bows (101) to the top section (23) of the sleeve (20). The locking holes (22) are formed sequentially in pairs in the sleeve (20).

The foot (30) is hollow, is mounted slidably in the bottom opening of the sleeve (20), has a top opening and a bottom end and may have a boot (31) and two locking holes (32). The boot (31) is attached to the bottom end of the foot (30). The locking holes (32) are formed near the top opening of the foot (30) and correspond to the locking holes (22) in the sleeve (20).

The adjusting device (40) is mounted in the top opening of the foot (30) to adjust the height of the crutch and may comprise a resilient member (41) and two circular buttons (42). The resilient member (41) is U-shaped and has two ends. The circular buttons (42) are formed respectively on opposite ends of the resilient member (41) and selectively engage the locking holes (32, 22) in the foot (30) and in the sleeve (20). When the circular buttons (42) engage the locking holes (32, 22) in the foot (30) and in the sleeve (20), the foot (30) is held in place. When the circular buttons (42) are pushed and disengage from the locking holes (32, 22) in the foot (30) and in the sleeve (20), the foot (30) can be pushed into or pulled out of the sleeve (20) to change the length of the crutch.

The crutch as described reduces the length of the attachment segment (15). The shorter attachment segment (15) decreases the material of the crutch and allows a person using the crutch to have a better view of the foot (30). Thereby, fewer accidents are likely to happen.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A crutch comprising
a body having
two bows parallel to each other and each bow having
a top end;
a bottom end;
a middle; and
an attachment segment formed near the bottom end, curving inwardly and having a length;
a pad attached to the top ends of the bows; and
a handgrip mounted between the middle of the bows;
a sleeve being hollow, attached to the attachment segments of the bows and having
a length longer than the length of the attachment segments;
a top section attached securely between the attachment segments of the bows; and
a bottom opening;
a foot mounted slidably in the bottom opening of the sleeve and having
a top opening; and
a bottom end; and
an adjusting device mounted in the top opening of the foot to adjust the height of the crutch.

2. The crutch as claimed in claim 1, wherein
the body further has a stationary end connector attached to the bottom end of the bows, and the stationary end connector has a central hole;
each attachment segment further has multiple fastening holes;
the sleeve extends through the central hole in the stationary end connector and further has two fastening elements extending respectively through the fastening holes in the attachment segments and attaching the bows to the top section of the sleeve.

3. The crutch as claimed in claim 1, wherein
each bow further has multiple through holes formed sequentially in pairs in the middle of the bows; and
the handgrip further comprises
a bolt extending through a through hole in one bow, the handgrip and a corresponding through hole in the other bow; and
a nut screwing onto the bolt to hold the handgrip in place.

4. The crutch as claimed in claim 2, wherein
each bow further has multiple through holes formed sequentially in pairs in the middle of the bows; and
the handgrip further comprises
a bolt extending through a through hole in one bow, the handgrip and a corresponding through hole in the other bow; and
a nut screwing onto the bolt to hold the handgrip in place.

5. The crutch as claimed in claim 1, wherein
the sleeve further has multiple locking holes formed sequentially in pairs;
the foot further has two locking holes formed near the top opening of the foot and corresponding to the locking holes in the sleeve; and
the adjusting device comprises
a resilient member being U-shaped and having two ends; and
two circular buttons formed respectively on opposite ends of the resilient member and selectively engaging the locking holes in the foot and the sleeve.

6. The crutch as claimed in claim 2, wherein
the sleeve further has multiple locking holes formed sequentially in pairs;
the foot further has two locking holes formed near the top opening of the foot and corresponding to the locking holes in the sleeve; and
the adjusting device comprises
a resilient member being U-shaped and having two ends; and
two circular buttons formed respectively on opposite ends of the resilient member and selectively engaging the locking holes in the foot and the sleeve.

7. The crutch as claimed in claim 3, wherein
the sleeve further has multiple locking holes formed sequentially in pairs;
the foot further has two locking holes formed near the top opening of the foot and corresponding to the locking holes in the sleeve; and
the adjusting device comprises
a resilient member being U-shaped and having two ends; and
two circular buttons formed respectively on opposite ends of the resilient member and selectively engaging the locking holes in the foot and the sleeve.

8. The crutch as claimed in claim 4, wherein
the sleeve further has multiple locking holes formed sequentially in pairs;
the foot further has two locking holes formed near the top opening of the foot and corresponding to the locking holes in the sleeve; and
the adjusting device comprises
a resilient member being U-shaped and having two ends; and
two circular buttons formed respectively on opposite ends of the resilient member and selectively engaging the locking holes in the foot and the sleeve.
